(19) United States
(12) Patent Application Publication
(10) Pub. No.: US 2016/0111222 A1
(43) Pub. Date: Apr. 21, 2016

(54) PEDOT:PSS BASED LAYER STACK, METHOD FOR FORMING THE SAME, AND USE THEREOF

(71) Applicant: National Taiwan University, Taipei (TW)

(72) Inventors: Chung-Chih Wu, Taipei (TW); Chun-Yang Lu, Taipei (TW)

(21) Appl. No.: 14/884,266

(22) Filed: Oct. 15, 2015

Related U.S. Application Data
(60) Provisional application No. 62/122,249, filed on Oct. 16, 2014.

(51) Int. Cl. H01G 9/20

(52) U.S. Cl. CPC H01G 9/2022; H01G 9/2027

(57) ABSTRACT

A PEDOT:PSS based layer stack and forming method are disclosed. The layer stack is with nanofibrillar and nanoporous structure, having PEDOT-richer surface. Additionally, applications of the layer stack are also disclosed.

### CROSS REFERENCE TO RELATED APPLICATIONS

This application claims priority to and the benefit of U.S. Provisional Patent Application Ser. No. 62/122,249, filed on Oct. 16, 2014, and entitled “Nanofibrillar, Nanoporous, and Electrochemically Active High-Conductivity Conducting Polymers, Method of Forming the Same, and Applications of the Same”, the disclosure of which is incorporated by reference in its entirety.

### BACKGROUND OF THE INVENTION

1. Field of the Invention

The present invention relates to polymer layer stack, and more particularly to PEDOT:PSS based layer stack.

2. Description of the Prior Art

Since its introduction, dye-sensitized solar cells (DSSCs) have been investigated extensively due to their various features and merits for applications in renewable energy. A typical DSSC consists of a transparent conductive substrate, a porous thin-film photoelectrode composed of TiO₂ nanoparticles, dyes, an electrolyte, and a counter electrode. The counter electrode, as one important component in DSSCs, is usually composed of a catalytic layer (e.g., thin platinum layer, Pt layer) and a conductive layer (e.g, fluorine-doped tin oxide, FTO). The role of the catalytic layer in the counter electrode of the DSSC is to catalyze the reduction of the I3− ions in the electrolyte produced during the regeneration of the oxidized dyes (through the oxidation of iodide ions in the electrolyte). Pt has been widely used as the catalytic layer in the DSSC counter electrode due to its excellent electrocatalytic activity for reduction of triiodide. Pt, however, is a rare and expensive material and may limit real DSSC applications. Accordingly, there is a craving for alternative Pt-free and more cost-effective materials for counter electrodes of DSSC.

Conducting polymers, like poly(3,4-ethylenedioxythiophene) (PEDOT), had been shown to possess the required electrochemical properties and be effective as the catalytic layer in DSSC counter electrodes. Due to its poor solubility in most of solvents, when used in DSSCs, PEDOT films usually cannot be formed by simple and straightforward solution coating, and instead usually need to be deposited by other more complicated simultaneous polymerization/deposition approaches (such as electrodeposition) onto the conductive FTO. As such, researchers have considered using the aqueous dispersion of PEDOT:poly(styrenesulfonate) (PEDOT:PSS), that can be directly coated from solutions, in DSSC counter electrodes. In PEDOT:PSS, PSS is introduced as the template for PEDOT polymerization so that stable dispersion can be obtained. It also serves as the oxidizing agent and the counterion for PEDOT, giving enhanced conductivity. PEDOT:PSS is readily available from commercial sources, has highly reproducible properties, and thus has been widely used in various optoelectronic applications. In recent years, tremendous progresses have also been made on enhancing the conductivity of PEDOT:PSS. By addition of various polar solvents or additives, such as dimethyl sulfoxide (DMSO), ethylene glycol (EG), sorbitol, hexafluoroacetone (HFA) etc., conductivity of PEDOT:PSS can be enhanced by orders of magnitude to ˜1000 S/cm, approaching that of widely used transparent conductors such as indium tin oxide and FTO. These properties together render it possible to use PEDOT:PSS not only as the catalytic layer in the counter electrode but also as the replacement of the transparent conductor below (e.g., FTO). Since both Pt and FTO are less cost-effective components in DSSCs, the relaization of Pt-free and FTO-free counter electrodes, particularly solution-processable/mechanically flexible/transparent/cost-effective ones, would benefit real applications of DSSCs.

Direct use of PEDOT:PSS or high-conductivity PEDOT:PSS (high-σ PEDOT:PSS) as the catalytic layer or the catalytic/conductive layer simultaneously in counter electrodes of DSSCs, however, in general suffer significantly lower efficiencies than DSSCs using Pt counter electrodes. This is presumably associated with the fact that in PEDOT:PSS films, PEDOT that mainly contributes to the catalytic capability is often surrounded and interfered by the insulating PSS. To remedy this, rather complicated synthetic approaches had been adopted to form nanostructured and/or nanocomposite PEDOT:PSS-based couter electrodes, so that the electrocatalytic properties of PEDOT:PSS-based counter electrodes can be enhanced. Alternatively, some others again were forced to deposit PEDOT (e.g., by less convenient electrodeposition etc.) on conductive PEDOT:PSS in order to form effective counter electrodes.

### SUMMARY OF THE INVENTION

In order to overcome the drawbacks of prior arts, the present invention provides various embodiments described below.

In certain embodiments, A PEDOT:PSS based layer stack is disclosed. The layer stack is with nanofibrillar and nanoporous structure, having PEDOT-richer surface.

In certain embodiments, an electrode and/or an electrical lead includes the PEDOT:PSS based layer stack.

In certain embodiments, a method for forming the layer stack is disclosed, comprising: providing a solution containing PEDOT:PSS, a solvent, and a co-solvent, wherein the co-solvent inducing phase separation between PEDOT and PSS; coating the solution on a substrate to form a pre-layer; baking the pre-layer to form a PSS:PEDOT layer; and repeating the coating step and baking step to form a next PSS:PEDOT layer onto a previous PSS:PEDOT layer, so as to fabricate the layer stack.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 shows the cyclic voltammograms for (a) one-layer low-σ PEDOT:PSS and one- to six-layer high-σ PEDOT:PSS (prepared with 5 vol. % DMSO), and (b) 5-layer high-σ PEDOT:PSS prepared with 2.5-15 vol. % DMSO.

FIG. 2(a) shows top-view SEM images (scale bar=100 nm) and FIG. 2(b) shows S(2p) XPS spectra of one-layer low-σ PEDOT:PSS (no DMSO addition) and one/three/five-layer high-σ PEDOT:PSS prepared with DMSO addition (10 vol. %). Peaks around the binding energies of 168 eV and 164 eV in XPS spectra correspond to the sulfur signals from the sulfonate of PSS and thiophene of PEDOT.

FIG. 3(a) shows top-view SEM images (scale bar=100 nm) and FIG. 3(b) shows S(2p) XPS spectra of multi-layer (5-layer) high-σ PEDOT:PSS prepared with 2.5-15 vol. % DMSO addition.

FIG. 4 shows J-V characteristics for (a) DSSCs with counter electrodes composed of low-σ PEDOT:PSS (1 layer) on FTO and 1-6 layers of high-σ PEDOT:PSS on FTO, and (b) DSSCs using the Pt/FTO counter electrode, the counter electrodes having 5 layers of PEDOT:PSS (on FTO) prepared with different DMSO concentrations (2.5-15 vol. %) and the Pt-free/FTO-free counter electrode having 5 layers of PEDOT:PSS (no FTO) prepared with 10 vol. % DMSO.

### DETAILED DESCRIPTION OF THE PREFERRED EMBODIMENTS

In the application, where an element or component is said to be included in and/or selected from a list of recited elements or components, it should be understood that the element or component can be one or more of the recited elements or components, or can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein.

The use of the terms “contain”, “contains”, “containing”, “include,” “includes”, “including,” “have,” “has,” or “having” should be generally understood as open-ended and non-limiting unless specifically stated otherwise.

A PEDOT:PSS based layer stack is disclosed. The layer stack is with nanofibrillar and nanoporous structure, having PEDOT-richer surface. The layer stack comprising 3 or more layers, or more preferably 5 to 10 layers.

In certain embodiments, an electrode and/or an electrical lead includes the PEDOT:PSS based layer stack. For example, a counter electrode for dye-sensitized solar cells (DSSC) comprises optionally a conductive substrate, and a catalyst layer including the above-mentioned layer stack, formed on one side of the substrate. The counter electrode does not include any platinum catalyst (called Pt-free). Furthermore, a DSSC comprising the counter electrode exhibits power conversion efficiency at least 8%.

In certain embodiments, a method for forming the layer stack is disclosed, comprising: providing a solution containing PEDOT:PSS, a solvent, and a co-solvent, wherein the co-solvent inducing phase separation between PEDOT and PSS; coating the solution on a substrate to form a pre-layer; baking the pre-layer to form a PSS:PEDOT layer; and repeating the coating step and baking step to form a next PSS:PEDOT layer onto a previous PSS:PEDOT layer, so as to fabricate the layer stack.

In the coating step, the co-solvent washes away part of the phase-separated PSS phase in the previous PSS:PEDOT layer(s), and contributing the formation of PEDOT-richer surface in the layer stack. The coating step and baking step are repeated for 3 or more times, or more preferably 5 to 10 times. So as to form the layer stack with nanofibrillar and nanoporous structure, having PEDOT-richer surface.

The requirement of the co-solvent is more polar and with higher boiling point than water. For example, dimethyl sulfoxide (DMSO), and the concentration of DMSO in the solution is 2.5 to 15 vol. %, or more preferably 5 to 10 vol. %

### EXAMPLE 1

### Preparation of High-Conductivity Conducting Polymer PEDOT:PSS with Nanofibrillar and Nanoporous Structures, PEDOT-Richer Surface Composition, and Enhanced Electrocatalytic Capability

PEDOT:PSS films of varied conductivity were prepared by spin-coating (e.g., 2000 RPM, 40 sec.) from the as-purchased aqueous solution (e.g., Clevios PH1000, Heraeus Co.) or from its mixture with the high-boiling point polar co-solvent, such as dimethyl sulfoxide (DMSO). The DMSO concentration (vol. %) was varied, e.g. from 0%, 2.5%, 5%, 10%, to 15%. Spin-coated PEDOT:PSS films were subsequently baked on a hot plate, e.g. at 130° C. for 15 minutes under ambient conditions. The stacking of PEDOT:PSS layers were achieved by repeated spin-coating and baking processes. One spin-coating yielded a layer thickness of ˜70 nm, and the total film thickness was roughly proportional to the number of spin-coating. Depending on different characterizations and uses, PEDOT:PSS films were coated onto either glass substrates or glasses precoated with the transparent conductor fluorine-doped tin oxide (FTO).

Electrical properties, surface characteristics, morphologies, and electrochemical properties of PEDOT:PSS films were characterized. The van der Pauw measurement was used to characterize the sheet resistance and conductivity of PEDOT:PSS films. Scanning electron microscopy (SEM) and atomic force microscopy (AFM) were used to characterize the morphology, surface topography/roughness and phase of various PEDOT:PSS films. X-ray photoelectron spectroscopy (XPS) was used to characterize the chemical compositions PEDOT:PSS films. XPS was conducted on a Thermo Scientific Theta Probe system with the monochromatic Al Kα X-ray source (hν=1486.6 eV). Cyclic voltammetry (CV) was employed to characterize the relative catalytic ability of the PEDOT:PSS films (coated on FTO glasses). The CV measurements were conducted using a three-electrode electrochemistry system (Gamry Instrument) and a scan rate of 50 mV/s. The electrolyte used was the acetonitrile solution containing 10 mM LiI, 1 mM I₂, and 100 mM LiClO₄. The PEDOT:PSS counter electrodes under testing were used as the working electrode, Pt foil as the counter electrode, and Ag/Ag⁺ as the reference electrode.

Adding the polar and high-boiling-point co-solvent DMSO into the PEDOT:PSS had been reported to substantially increase the conductivity of PEDOT:PSS. With adding the 5 vol. % DMSO co-solvent into the PEDOT:PSS aqueous solution, the resulted PEDOT:PSS films achieved a conductivity of 720-950 S/cm (Table 1), as determined by the van der Pauw measurement). Such conductivity is orders of magnitude higher than that (˜0.07 S/cm, Table 1) of PEDOT:PSS films (low-σ PEDOT:PSS) coated from original (as-purchased) aqueous solutions. According to previous studies, the enhanced conductivity of PEDOT:PSS could be attributed to a strong phase separation of conducting PEDOT and insulating PSS domains induced by addition of DMSO, leading to formation of more organized conducting pathways of PEDOT and thus much more efficient charge conduction.

TABLE 1
Characteristics of the PEDOT:PSS films prepared with varied number of spin-coating/stacking and varied DMSO concentrations.

| DMSO vol. % | 0 | 2.5 | 5 | 5 | 5 | 5 | 5 | 5 | 10 | 15 |
|---|---|---|---|---|---|---|---|---|---|---|
| No. of layers | 1 | 5 | 1 | 2 | 3 | 4 | 5 | 6 | 5 | 5 |
| Sheet | 2.00 × 10⁶ | 40.60 | 197.14 | 90.35 | 55.80 | 42.45 | 30.10 | 27.30 | 29.80 | 33.70 |
| resistance | | | | | | | | | | |
| (Ω/□) | | | | | | | | | | |
| Thickness | 71 ± 2.2 | 352 ± 4.8 | 70 ± 2.0 | 139 ± 2.8 | 207 ± 3.0 | 261 ± 3.7 | 351 ± 4.1 | 409 ± 5.5 | 350 ± 4.4 | 345 ± 4.6 |
| (nm) | | | | | | | | | | |
| Conductivity | 0.07 | 700 | 724 | 796 | 865 | 903 | 947 | 896 | 957 | 860 |
| (S/cm) | | | | | | | | | | |
| CV I_{pc} | 0.90 | 2.30 | 1.96 | 2.07 | 2.32 | 3.01 | 3.33 | 2.46 | 3.67 | 2.94 |
| (mA/cm²) | | | | | | | | | | |

The thicknesses of High-σ PEDOT:PSS films was accumulated and their sheet resistance was reduced by stacking of PEDOT:PSS layers through repeated spin-coating and baking processes, as summarized in Table 1. One spin-coating yielded a layer thickness of ˜70 nm and a sheet resistance of 197Ω/□. The total film thickness/sheet resistance was roughly proportional/inversely proportional to the number of spin-coating, respectively. With stacking one to six High-σ PEDOT:PSS layers, the sheet resistance dropped from 197 to 30Ω/□ (Table 1). One should also notices that the conductivity of high-conductivity PEDOT:PSS films is increased with repeated coating/stacking (e.g. from 724 S/cm of one-coating sample to ˜950 S/cm of 5-coating sample).

Electrical properties (sheet resistance and conductivity) of such 5-layer-stack PEDOT:PSS films having different DMSO concentrations (2.5-15 vol. %) are summarized in Table 1. As consistent with previous literature reports,^{[9,20]} highest conductivity of ˜950 S/cm was achieved around the DMSO concentration of 5-10%.

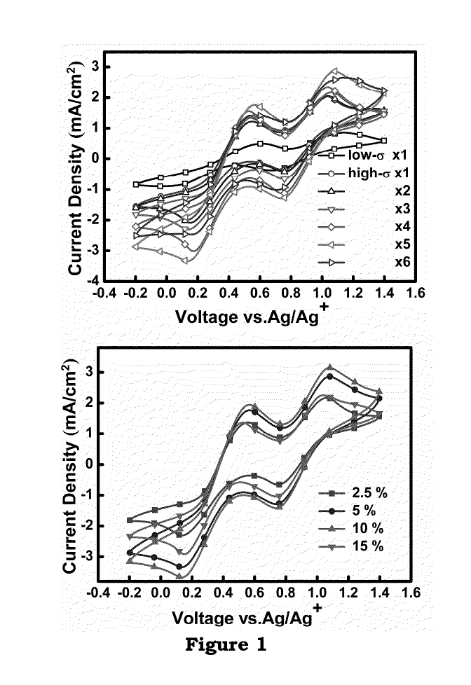

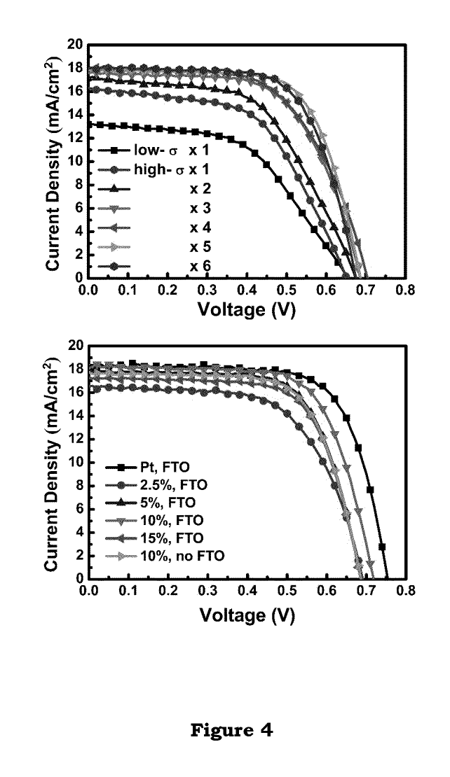

FIG. 1(a) shows the cyclic voltammograms for one-layer low-σ PEDOT:PSS and one- to six-layer high-σ PEDOT:PSS (prepared with 5 vol. % DMSO). In these cyclic voltammograms, the cathodic current peaks (I_{PC}) between 0.1 V to 0.2 V correspond to the reduction of I₃− ions through interaction with PEDOT:PSS. Thus, in general, the magnitude of the I_{PC} represents the catalytic capability (activity) of a counter electrode toward reduction of I₃− in DSSCs. As seen in FIG. 1(a) and Table 1, I_{PC}'s of high-σ PEDOT:PSS in general are larger than that of low-σ PEDOT:PSS. Yet more intriguingly, for high-σ PEDOT:PSS, I_{PC} initially increases with the number of spin-coating/stacking and eventually saturates around 5 spin-coating/stacking. Such CV characteristics are highly consistent with photovoltaic characteristics of DSSCs using corresponding PEDOT:PSS films to be described later (FIG. 4(a)), indicating strong correlation of DSSC characteristics and electrocatalytic characteristics of various PEDOT:PSS films. Similarly, FIG. 1(b) shows the cyclic voltammograms for 5-layer high-σ PEDOT:PSS prepared with 2.5-15 vol. % DMSO. As seen in FIG. 1(b) and Table 1, I_{PC} initially increases with the concentration of DMSO and eventually saturates around 5-10 vol. % DMSO. Such CV characteristics again are highly consistent with photovoltaic characteristics of DSSCs using corresponding PEDOT:PSS films to be described later (FIG. 4(b)).

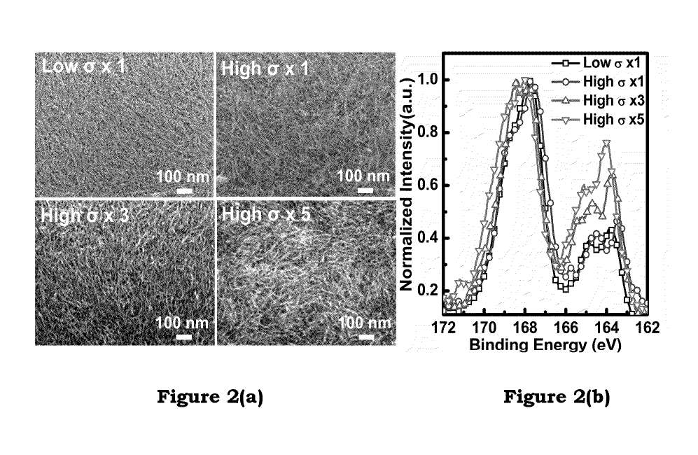

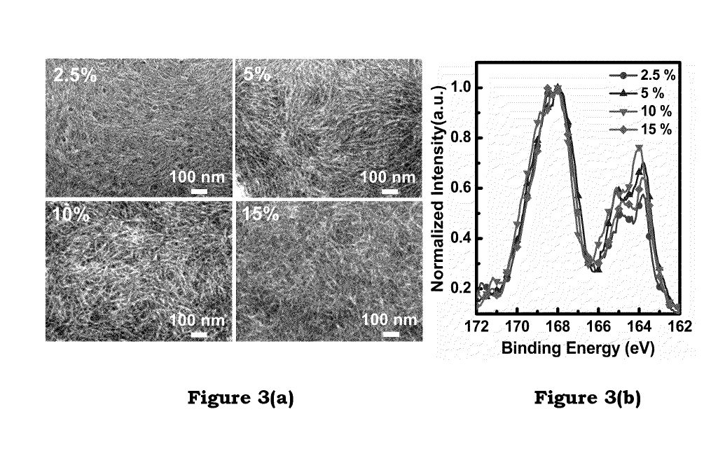

To understand mechanisms for enhanced electrochemical and photovoltaic characteristics, surface morphologies and compositions of various PEDOT:PSS films were examined by scanning electron microscopy (SEM) and X-ray photoemission spectroscopy (XPS). FIG. 2(a) shows top-view SEM images of one-layer low-σ PEDOT:PSS (no DMSO addition) and one/three/five-layer high-σ PEDOT:PSS prepared with DMSO addition. FIG. 2(a) reveals prominent spontaneous formation of nano-fibrillar and nanoporous structures in PEDOT:PSS films prepared with DMSO addition and repeated spin-coating/stacking. The nanofiber-like structures seemingly become more prominent, thicker, and more extended with repeated spin-coating/stacking and meanwhile the surfaces also gets more nanoporous, wherein the average pore size ranges from 5 to 50 nm. FIG. 2(b) shows the S(2p) XPS spectra of these PEDOS:PSS films, in which peaks around the binding energies of 168 eV and 164 eV correspond to the sulfur signals from the sulfonate of PSS and thiophene of PEDOT, respectively. While one spin-coating makes no distinguishable difference in the PEDOT/PSS ratio for films prepared either with or without DMSO addition, the surface ratio of PEDOT for films prepared with DMSO addition increases significantly (i.e., richer in PEDOT) with repeated spin-coating/stacking. Similarly, FIG. 3(a) and FIG. 3(b) shows the top-view SEM images and S(2p) XPS spectra for multi-layer PEDOT:PSS prepared with 2.5-15 vol. % DMSO. More prominent, more extended, more nanoporous, and PEDOT-richer nanofiber-like surface structures are obtained with increasing the DMSO concentration, except for the highest DMSO concentration of 15%. Too much DMSO addition appears to disturb organization of PEDOT during film formation, which may explain the drop of conductivity, electrocatalytic capability and photovoltaic performance with the PEDOT:PSS prepared with 15 vol. % DMSO.

These SEM and XPS results together suggest several mechanismic phenomena in PEDOS:PPS film formation: (i) appropriate addition of co-solvent DMSO induces phase separation between PEDOT and PSS and more organized (nanofiber-like) structures of PEDOT; (ii) repeated spin-coating (with water/DMSO mixture therein) continues to strengthen organization of PEDOT, giving more prominent and extended PEDOT structures; (iii) repeated spin-coating (with water/DMSO mixture therein) appears to also facilitate washing away of the (phase-separated) insulating PSS phase, giving PEDOT-richer and more electrochemically active surfaces; (iv) the above two factors perhaps also contribute to formation of more nanoporous structures. Such morphological and compositional evolution well coincides with enhancement in CV characteristics and photovoltaic characteristics of DSSCs using corresponding PEDOT:PSS films. With more nanofiber-like, more nanoporous, and PEDOT-richer surface structure, the enhanced electracatalytic and photovoltaic characteristics thus can be attributed to larger surface areas and more electrochemical active surface compositions. In addition, the enhanced conductivity of PEDOT:PSS films (prepared with DMSO addition) with repeated spin-coating/stacking (Table 1), although less dramatic, perhaps can also be explained by such morphological and compositional evolution.

In summary, we report that by stacking of high-conductivity PEDOT:PSS layers through repeated solution coating (spin-coating) with the highly polar, high-boiling-point co-solvent addition like DMSO, nanofibrillar, nanoporpous, and PEDOT-richer surface structures are spontaneously induced in resulted films. Such nanostructured PEDOT:PSS films possess both high conductivity and enhanced electrocatalytic capability, such as counter electrodes of DSSCs. The way of forming such nanostructured, high-conductivity, and electrochemically effective conducting polymers and DSSC counter electrodes has particular merits of being simple/cost-effective and requiring low processing temperatures. In addition, such PEDOT:PSS films are generally transparent and mechanically flexible. They therefore shall be also applicable and useful for flexible DSSCs, (semi-)transparent/colored DSSCs, bifacial DSSCs, and any other applications that could benefit from their both high conductivity and effective electrocatalytic capability.

### EXAMPLE 2

### Applications of High-Conductivity Conducting Polymer PEDOT:PSS with Nanofibrillar and Nanoporous Structures, PEDOT-Richer Surface Composition, and Enhanced Electrocatalytic Capability as the Electrocatalytic Layer in Counter Electrode of DSSCs

The photovoltaic characteristics of using PEDOT:PSS as the catalytic layer in counter electrodes (with the PEDOT:PSS/FTO structure) for DSSCs were evaluated using a typical sandwich-type DSSC cell, which comprised a 12-μm-thick layer of 20-nm-sized anatase TiO₂ nanoparticles, a 4-μm-thick scattering layer of 400-nm-sized TiO₂ nanoparticles, the N719 dye sensitizer, and the electrolyte composed of 0.6 M 1-butyl-3-methylimidazolium iodide (BMII), 0.03 M 12, 0.5 M 4-tert-butylpyridine, and 0.1 M guanidinium thiocyanate in a mixture of acetonitrile-valeronitrile (85:15, v/v). In fabrication of DSSC devices, a layer of 20-nm-sized anatase TiO₂ nanoparticles was first coated on the cleaned FTO substrate by the doctor blading. After drying at 120° C., another layer of 400-nm-sized anatase TiO₂ nanoparticles was then coated as the light scattering layer. The resulting working electrode was composed of a 12-μm-thick transparent TiO₂ nanoparticle layer (average particle size: 20 nm) and a 4-μm-thick TiO₂ scattering layer (average particle size: 400 nm). The nanoporous TiO₂ electrodes were then heated in an atmospheric oven first by gradually ramping the temperature from 150° C. to 500° C. and then at 500° C. for 30 min. After cooling, the nanoporous TiO₂ electrodes were immersed into a dye solution at room temperature for 24 hours for dye adsorption. The dye solution was composed of 0.5 mM ruthenium dye N719, [cis-di(thiocyanato)-N-N′-bis(2,2′-bipyridyl-4-carboxylic acid-4′-tetrabutyl-ammonium carboxylate) ruthenium (II)], and 0.5 mM chenodeoxycholic acid (CDCA, as a co-adsorbent) in the acetonitrile/tert-butanol mixture (1:1). PEDOT:PSS counter electrodes (on FTO glasses or on glasses for FTO-free counter electrodes) for the DSSCs were prepared as described in the previous section. The dye-adsorbed TiO₂ working electrode and the counter electrode were then assembled into a sealed DSSC with a sealant spacer between two electrode plates. A drop of the electrolyte solution [0.6 M 1-butyl-3-methylimidazolium iodide (BMII), 0.03 M I₂, 0.5 M 4-tert-butylpyridine, and 0.1 M guanidinium thiocyanate in a mixture of acetonitrile-valeronitrile (85:15, v/v)] was injected into the cell through a drilled hole. Finally, the hole was sealed using the sealant and a cover glass. For a fair comparison, a reference DSSC having the conventional Pt counter electrode was also prepared and tested. The Pt counter electrode was prepared by depositing a 40-nm-thick Pt film on the FTO glass by e-beam evaporation. The photocurrent-voltage (J-V) characteristics of the DSSCs were measured under illumination of the simulated AM1.5G solar light from a 300-W Xenon lamp solar simulator. The incident light intensity was calibrated as 100 mW/cm². The photocurrent-voltage characteristics of DSSCs were used to extract the short-circuit current density (J_{SC}), open-circuit voltage (V_{OC}), fill factor (FF), and power conversion efficiency (Eff.) of the DSSCs. The testing cell was covered with a mask having an aperture of 0.125 cm² during the measurement.

FIG. 4(a) shows the J-V characteristics measured under simulated AM1.5G solar illumination (100 mW/cm²), for DSSCs with counter electrodes composed of low-σ PEDOT:PSS (1 layer) on FTO and 1-6 layers of high-σ PEDOT:PSS on FTO. Their photovoltaic characteristics, such as the short-circuit current density (J_{SC}), open-circuit voltage (V_{OC}), fill factor (FF), and power conversion efficiency (Eff.), are also summarized in Table 2. For comparison, a DSSC having the conventional Pt counter electrode (40-nm Pt e-beam evaporated on FTO) was also prepared and tested (FIG. 4(b) and Table 2). As expected from previous literature reports, DSSCs using both 1-layer low-σ PEDOT:PSS/FTO and 1-layer high-σ PEDOT:PSS/FTO counter electrodes exhibit much poorer photovoltaic characteristics (with power conversion efficiencies of 4.52% and 5.82%) than the conventional Pt device (with power conversion efficiency of 9.77%). Yet, intriguingly by simply stacking high-σ PEDOT:PSS layers through repeated spin-coating, photovoltaic characteristics and power conversion efficiencies of DSSCs were substantially enhanced. With stacking 5 layers of high-σ PEDOT:PSS, the efficiency was improved from 5.82% (1 layer) to 8.38% (5 layers).

TABLE 2
Characteristics of DSSCs using different counter electrodes.

| Counter Electrode | FTO/PEDOT:PSS | | | | | | | | | | PEDOT:PSS | FTO/Pt |
|---|---|---|---|---|---|---|---|---|---|---|---|---|
| DMSO vol. % | 0 | 2.5 | 5 | 5 | 5 | 5 | 5 | 5 | 10 | 15 | 10 | N/A |
| No. of layers | 1 | 5 | 1 | 2 | 3 | 4 | 5 | 6 | 5 | 5 | 5 | N/A |
| J_{sc} (mA/cm²) | 13.17 | 16.55 | 16.31 | 17.13 | 17.57 | 17.98 | 17.94 | 17.96 | 18.08 | 17.27 | 17.75 | 18.38 |
| V_{oc} (V) | 0.66 | 0.70 | 0.66 | 0.68 | 0.69 | 0.71 | 0.69 | 0.68 | 0.72 | 0.70 | 0.69 | 0.75 |
| FF | 0.50 | 0.61 | 0.54 | 0.55 | 0.61 | 0.61 | 0.68 | 0.67 | 0.69 | 0.68 | 0.68 | 0.71 |
| Eff. (%) | 4.52 | 7.10 | 5.82 | 6.44 | 7.51 | 7.62 | 8.38 | 8.15 | 9.01 | 8.08 | 8.29 | 9.77 |

Counter electrodes having 5 layers of PEDOT:PSS (on FTO) prepared with different DMSO concentrations (2.5-15 vol. %) were further tested for DSSCs. FIG. 4(b) shows J-V characteristics of DSSCs using such counter electrodes under simulated solar illumination, and their photovoltaic characteristics are summarized in Table 2. Significant influence of the DMSO concentration on photovoltaic characteristics is seen. The highest conversion efficiency of up to 9.01% was obtained around 10 vol. % DMSO concentration, approaching the efficiency of the Pt device.

In brief, for DSSCs using PEDOT:PSS based counter electrodes, a conversion efficiency close to that of the Pt device could be obtained by repeatedly stacking PEDOT:PSS layers prepared with the appropriate DMSO concentration. Such improvement cannot be simply attributed to enhanced conductivity and reduced sheet resistance of PEDOT:PSS films, since they were used in combination with the conductive FTO layer beneath having a much lower sheet resistance of ˜7.5Ω/□. Instead, results here are also associated with enhanced electrocatalytic characteristics of PEDOT:PSS films according to cyclic voltammetry (CV) of different PEDOT:PSS films (coated on FTO glasses).

### EXAMPLE 3

### Applications of High-Conductivity Conducting Polymer PEDOT:PSS with Nanofibrillar and Nanoporous Structures, PEDOT-Richer Surface Composition, and Enhanced Electrocatalytic Capability as the Dual-Function Catalytic/Conductive Layer in Counter Electrode of DSSCs

Since repeated spin-coating/stacking PEDOT:PSS layers prepared with appropriate DMSO addition can simultaneously provide enhanced electrocatalytic capability and low sheet resistance, it is possible to remove the conductive FTO layer beneath and use such stacked high-σ PEDOT:PSS layers as the Pt-free and FTO-free counter electrodes for DSSCs. For comparison, J-V characteristics of the DSSC using 5-layer PEDOT:PSS prepared with 10 vol. % DMSO (no FTO below) as the counter electrode are also shown in FIG. 4(b), with its photovoltaic characteristics being also summarized in Table 2. Even without the FTO layer below the high-σ PEDOT:PSS layers, the DSSC retained J-V and photovoltaic characteristics (with a power conversion efficiency of ˜8.3%) similar to those of DSSCs having FTO/PEDOT:PSS counter electrodes in this work and any other more complicated FTO-free Pt-free counter electrodes previously reported. Such results clearly indicate promise of such spontaneously formed nanofibrillar/nanoporous high-conductivity PEDOT:PSS for low-cost high-performance DSSC counter electrodes and devices.

In summary, by stacking of high-conductivity PEDOT:PSS layers through repeated solution coating (spin-coating) with the highly polar, high-boiling-point co-solvent addition like DMSO, nanofibrillar, nanoporpous, and PEDOT-richer surface structures are spontaneously induced in resulted films. Such nanostructured PEDOT:PSS films possess both high conductivity and enhanced electrocatalytic capability. Such nanostructured high-conductivity and highly electrochemically active PEDOT:PSS can be used as the effective electrocatalytic layer in Pt-free counter electrodes or the dual-function electrocatalytic/conductive layer in Pt-free/FTO-free counter electrodes of DSSCs, giving DSSC performance similar to those of conventional DSSCs using Pt-containing and/or FTO-containing counter electrodes. 15

### EXAMPLE 4

### Other Possible Applications of High-Conductivity Conducting Polymer PEDOT:PSS with Nanofibrillar and Nanoporous Structures, PEDOT-Richer Surface Composition, and Enhanced Electrocatalytic Capability

By stacking of high-conductivity PEDOT:PSS layers through repeated solution coating (spin-coating) with the highly polar, high-boiling-point co-solvent addition like DMSO, nanofibrillar, nanoporpous, and PEDOT-richer surface structures are spontaneously induced in resulted films. Such nanostructured PEDOT:PSS films possess both high conductivity and enhanced electrocatalytic capability. The way of forming such nanostructured, high-conductivity, and electrochemically effective conducting polymers has particular merits of being simple/cost-effective and requiring low processing temperatures. In addition, such PEDOT:PSS films are generally transparent and mechanically flexible. They therefore shall be also applicable and useful for counter electrodes of flexible DSSCs, counter electrodes of (semi-)transparent/colored DSSCs, counter electrodes of bifacial DSSCs, electrodes for electrochromic devices, for uses in batteries, for uses in supercapacitors, and any other applications that could benefit from their high conductivity, effective electrocatalytic capability, and nanostructures.

This invention provides a high-conductivity conducting polymer PEDOT:PSS with nanofibrillar and nanoporous structures, PEDOT-richer surface composition, and enhanced electrocatalytic capability for applications that would require high conductivity and strong electrochemical activity.

This invention also provides the method to prepare such high-conductivity conducting polymer PEDOT:PSS with nanofibrillar and nanoporous structures, PEDOT-richer surface composition, and enhanced electrocatalytic capability. By repeated stacking of aqueous dispersion of PEDOT:PSS with co-solvent addition through solution coating (e.g., spin coating) effectively induces spontaneous formation of nanofibrillar, nanoporous, and PEDOT-richer surface structures and enhanced electrocatalytic capability in resulted high-conductivity PEDOT:PSS films. Both conductivity and electrocatalytic characteristics are enhanced by such a method.

This invention also provide example applications using such high-conductivity conducting polymer PEDOT:PSS with nanofibrillar and nanoporous structures, PEDOT-richer surface composition, and enhanced electrocatalytic capability. DSSCs using such spontaneously nanostructured high-conductivity PEDOS:PSS either as the catalytic layer or the simultaneous catalytic/conductive layer in counter electrodes exhibit performances comparable to those using more expensive Pt.

The invention here provides an effective, simple, and economic material and approach, that is solution processable/low-temperature processable/mechanically flexible/transparent/cost-effective, for counter electrodes of DSSCs and other applications requiring high conductivity, electrocatalytic capability, and nanostructures.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A PEDOT:PSS based layer stack, with nanofibrillar and nanoporous structure, having PEDOT-richer surface.

2. The layer stack of claim 1, comprising 3 or more layers.

3. The layer stack of claim 1, comprising 5 to 10 layers.

4. The layer stack of claim 1, wherein the average pore size ranges from 5 to 50 nm.

5. An electrode and/or an electrical lead including the layer stack of claim 1.

6. A Pt-free counter electrode for dye-sensitized solar cells (DSSC), comprising:
Optionally a conductive substrate; and
A catalyst layer including the layer stack of claim 1, formed on one side of the substrate.

7. The counter electrode of claim 6, wherein the conductive substrate is indium tin oxide (ITO) or fluorine-doped tin oxide.

8. A dye-sensitized solar cell (DSSC) comprising the counter electrode of claim 6, and the power conversion efficiency is at least 8%.

9. A method for forming the layer stack of claim 1, comprising:
providing a solution containing PEDOT:PSS, a solvent, and a co-solvent, wherein the co-solvent inducing phase separation between PEDOT and PSS;
coating the solution on a substrate to form a pre-layer;
baking the pre-layer to form a PSS:PEDOT layer; and
repeating the coating step and baking step to form a next PSS:PEDOT layer onto a previous PSS:PEDOT layer, so as to fabricate the layer stack of claim 1.

10. The method of claim 9, wherein the co-solvent is more polar and with higher boiling point than water.

11. The method of claim 9, wherein the co-solvent is dimethyl sulfoxide (DMSO), and the concentration of DMSO in the solution is 2.5 to 15 vol. %.

12. The method of claim 11, wherein concentration of DMSO in the solution is 5 to 10 vol. %.

13. The method of claim 9, in the coating step, the co-solvent washes away part of the phase-separated PSS phase in the previous PSS:PEDOT layer(s), and contributing the formation of PEDOT-richer surface in the layer stack.

14. The method of claim 9, the coating step and baking step are repeated for 3 or more times.

15. The method of claim 9, the coating step and baking step are repeated for 5 to 10 times.
